(19) United States
(12) Patent Application Publication
(10) Pub. No.: US 2016/0113309 A1
(43) Pub. Date: Apr. 28, 2016

(54) FOOD PASTE

(71) Applicant: University College Dublin, National University of Ireland, Dublin, Dublin (IE)

(72) Inventors: Shane Ward, Stilorgan (IE); Gerard Corkery, Swords (IE); Maeve Cushen, Dublin (IE); Liam Brennan, Ballyragget (IE); Justin Carton, Dublin (IE)

(21) Appl. No.: 14/881,353

(22) Filed: Oct. 13, 2015

Related U.S. Application Data
(60) Provisional application No. 62/067,497, filed on Oct. 23, 2014.

(51) Int. Cl. A23L 1/00; A23L 1/09; A23P 1/08; A23L 1/275

(52) U.S. Cl. CPC A23L 1/0047; A23L 1/275; A23L 1/09; A23P 1/085; A23P 2001/089; A23V 2002/00

(57) ABSTRACT

A system for applying indicia to food products comprises a dispenser for successively dispensing a quantity of food paste onto a respective surface of a portion of food. The food paste comprises a carrier, a setting agent and a contrasting agent. A fusing unit fuses a dispensed portion of the paste to provide at least one solid indicium on the food product, the indicium optically contrasting with the portion of food.

### RELATED APPLICATIONS

This application claims the benefit of provisional patent application Ser. No. 62/067,497, filed Oct. 23, 2014, the disclosure of which is hereby incorporated herein by reference in its entirety.

### FIELD

The present invention relates to a food paste and a system and method for applying indicia to food products.

### BACKGROUND

Labelling of food products has become increasingly important both for quality control and to indicate to consumers the provenance of foodstuffs.

While labelling food packaging can provide a degree of assurance to consumers, in some cases, it would be preferable for a food product itself to be labelled.

While food compatible adhesive labels can be employed, for example, of the type applied to fruit, it will be appreciated that these can typically be removed or possibly tampered with and in some cases, these may not provide the level of assurance required by consumers. Discrete labels of course also result in waste product and so may not be desirable from an environmental point of view.

For some products it is possible to apply a label directly to the product, for example, by inkjetting a food grade ink onto the product to provide either human or machine readable indicia. This approach is useful for solid and dry food products or shelled products, for example, eggs.

Such an approach is less useful for hydrous or oily products such as meat or fish where if indicia were printed directly onto the product, the ink would bleed into the product and within a relatively short time, the indicia comprising the label would be illegible.

It is an object of the present invention to provide an improved system for labelling food products.

### SUMMARY

According to a first aspect of the present invention there is provided a food paste comprising a carrier, a setting agent and a contrasting agent, a portion of said paste being selectively fusible to define a solid indicium optically contrasting with an underlying portion of food.

Preferably, said setting agent changes color or opacity when fused.

Further preferably, said setting agent comprises a sugar which caramelizes when heated.

In another aspect, there is provided a system for applying indicia to food products, the system comprising a dispenser for successively dispensing a quantity of food paste according to the first aspect of the invention onto a respective surface of a portion of food; and a fusing unit for fusing a dispensed portion of said paste to provide at least one solid indicium on said food product, said indicium optically contrasting with said portion of food.

Preferably, said fusing unit is arranged to produce at least one focused light beam.

Preferably, said light beam is a laser light beam.

In some embodiments, the focused light beam is arranged to cause a change in color or opacity of an exposed fused portion of said paste.

In alternative embodiments, the focused light beam is arranged to ablate an exposed portion of said paste while fusing a side wall of the ablated portion to cause a change in color or opacity of said fused side wall. In such embodiments, the unexposed portion of said paste can be allowed to set passively. Also in such embodiments, the focused light beam can be arranged to cause a change in color of a portion of a surface of said food product exposed by said ablation.

Preferably, the food product comprises meat and more preferably, skinless meat.

The invention finds particular utility in applying indicia to the external surface of a fibrous fillet of meat where the meat fibers run generally parallel to the surface of the meat to which the indicia are applied. Such meat products can present a smooth sheath-like tissue such as an epimysium or a sausage casing (intestinal epithelial, or imitation thereof) suitable for applying indicia according to the invention.

In a particularly useful embodiment, the food product comprises a poultry fillet.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

Various embodiments of the present invention will now be described, by way of example, with reference to the accompanying, in which:

FIG. 1 is a schematic diagram of a system for applying indicia to food products according to one embodiment of the invention;

FIG. 2 is a cross-sectional view of a portion of an indicium applied according to one embodiment of the present invention; and

FIG. 3 is a cross-sectional view of a portion of an indicium applied according to one embodiment of the present invention.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

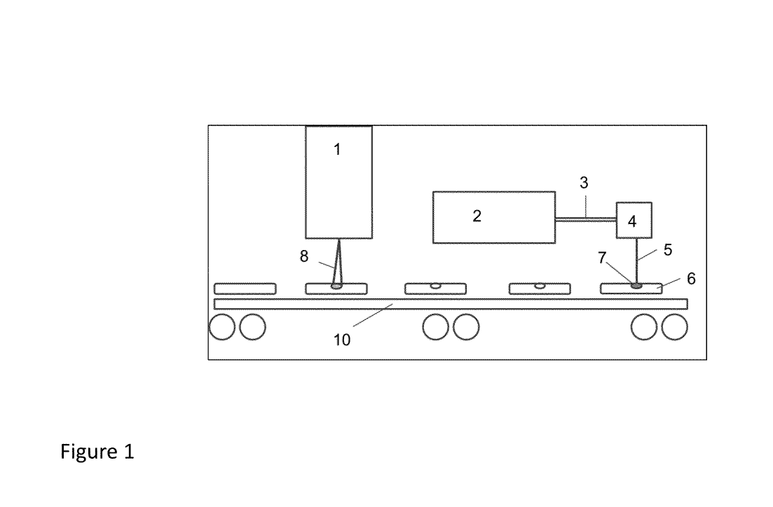

An exemplary system for applying a label to a food product is shown in FIG. 1. In the example, the food product comprises a series of meat fillets (6) fed on a conveyor (10) first past a paste dispenser (1) and then past a paste fusing system (2-4).

Each meat product (6) to be labelled can be placed on or in a suitable support (not shown) for its dimensions. A support can comprise a component of the conveyor or, for example, the meat product can be transported in a support comprising a container providing a portion of the final product packaging and once the label is applied as described below, the packaging can be sealed. In certain other embodiments, the meat product can be transported in a sealed package and the paste fusing system (2-4) can fuse the paste though the product packaging. In this case, a packaging sub-system (not shown) would be located between the paste dispenser (1) and the paste fusing system (2-4)—and the packaging would need to suitably co-operable with the fusing system (2-4).

In the embodiment, each support including at least one meat product is placed on a system (10) which moves relative to the dispenser (1) and fusing system (2-4), however, the converse can also be the case. Thus, in order to enable the system to locate the product (6) suitably in relation to the paste dispenser (1) and the fusing system (4) to label the surface of the meat product (6) with the required indicia (7), one or more of the paste dispenser (1), fusing system (4) or the products (6) need to move relative to one another.

In any case, the system can include any type of robot or any type of coordinate table or a combination of both systems. This system can also include an automatic position control system for controlling the position of the meat products. Such systems are well known and are not shown in the figure or discussed in more detail here.

Again, the application of a portion of paste (8) to the surface of each product (6) can be achieved with any number of standard industrial application apparatus and processes. In the example, a non-contact mechanism inkjets the paste (8) onto the surface of the food product.

In the embodiment, radiation from a laser source (2) is channeled by any suitable beam guiding system (3), for example, a mirror system or an optical fiber, depending on the type of laser source (2) used, to a beam focusing and directing system (4). The focusing and directing system (4) is machine controlled to determine an x,y location of a focused beam (5) on the surface of the product so as to fuse the portion of paste previously applied to the surface of the product.

In the system of FIG. 1, the radiation from the laser source (2) can be focused within the directing system (4) by a lens or group of lenses, or by a mirror or group of mirrors. In a particular embodiment, the focusing system comprises a pair of mirrors (not shown), one of which is planar and the other is parabolic. In other embodiments, the focusing system could comprise a simple lens, a dual-focus lens or a group of lenses.

In any case, the system thus applies a portion of a paste to the surface of the meat followed by directing radiation from the laser source onto the applied paste area to fuse the paste.

In the illustrated embodiment, the portion of paste is applied as a homogeneous patch to the surface of the meat and the directing system (4) guides a focused beam (5) across the patch of paste to selectively fuse the paste so defining one or more indicia comprising the fused portions of the paste. In some implementations, unfused portions of the paste can be wiped away, but as will be explained below, this may not be necessary where the paste includes an agent whose opacity or color changes significantly when fused so as to provide a contrast both with the surface of the underlying meat product, but also with unfused portions of the patch of paste. Alternatively, unfused portions of the paste can be washed away with a suitable solvent which does not affect the fused portions of the paste.

In other embodiments, the portion of paste is printed in a pattern corresponding to the required indicia, for example, with an inkjet printer and the portion of paste is blanket exposed by a static beam to fuse the paste. It may be regarded as a disadvantage that limited portions of the underlying product could be exposed to the beam and so could be affected by the beam; but exposing the underlying product during the application process could also result in a more robust and durable indicium and so could also be regarded as advantageous.

In a still other implementation, the portion of paste is again printed as a pattern, but the focused beam is also guided to follow the same pattern to only fuse the paste without affecting the underlying product.

In any case, it will be appreciated that using any of the above described variants, it is possible to selectively fuse a portion of paste by contrast to any remaining paste and the underlying meat product to define a solid human or machine readable indicium on the meat product.

While the above described embodiments operate with laser power and exposure time which need not affect the underlying product, it will be appreciated that in some applications, it could be desirable to employ higher power lasers which can cut into the surface of the product to enhance the rigidity and contrast of the final indicium.

In each case, it is useful to employ a system with a large focal length so that the focused laser beam (5) has a high depth of focus. In some cases, this focal length can be greater than 80 mm. Good results have been obtained with focal lengths between 120 and 400 mm.

To provide the desired indicia (7) on the meat products (6) after paste application, one or both of the paste dispenser (1) and the beam focusing and directing system (4) are connected to a control system (computer, numerical control system or the like) which is not included in the figure because it is commonly used in industrial systems. The dispenser (1) can dispense the paste in a required fashion and/or the focused beam (5) thus can describe the movements corresponding to the indicium (7) which has been set in said control system on the paste portion on the surface of the meat product to be labelled.

Where a laser source is employed, the laser radiation can come from a laser source of any wavelength, such as for example a CO₂, CO, N₂, Nd:YAG, Er:YAG, Nd:glass, Yb:YAG, Ruby, HeNe, HeCd, HeHg, Cu, I, Ar, Kr laser, a laser diode, a fiber laser, a disk laser, a chemical laser, an excimer laser, an alexandrite laser, an emerald laser or a dye laser. Among these sources, optimal results have been obtained using CO₂ lasers. The power necessary for this type of lasers can be between 0.1 and 600 W and the application time of the beam can be sufficient to selectively fuse the paste without affecting the underlying meat product.

The paste formulation contains a contrast agent (e.g. E100-E199), a carrier (e.g. Acetic Acid, Ethyl Ether, Acetone, Acetonitrile, Benzene, n-Hexane, Hydrochloric Acid, tert-Butanol, Carbon Tetrachloride, MTBE, Chloroform, Cyclohexane, Ethanol, Dichloromethane, Diethyl Ether, Tetrahydrofuran, Trifluoroacetic Acid, Dioxane, Cyclopentane, Ethyl Acetate, Ethylene Dichloride, Heptane, Methanol, Methylene Chloride, Xylene, Petroleum Ether, iso-Propanol, n-Propanol, Water, Pentane) and a setting agent (e.g. a sugar). Among these variants, optimal results have been obtained using TiO₂ (E171), ethanol and fructose. Note that some variants of E171 can include up to 2% SiO₂.

When the size of the label indicia (7) to be defined is relatively large, two or more laser sources (2) can be used in a synchronized manner to complete the indicia (7) in a reduced time period.

A variant of the embodiment could use several laser sources (2) in a synchronized manner such that indicia (7) on each meat product (6) comprising a matrix of marks can be defined, each laser source marking a dot/line or a limited group of dots/lines. The combination of such dots/lines thus gives rise to the desired indicia (7).

The following is a practical example for marking a product: a paste (44% ethanol, 19% TiO₂ and 37% fructose) of volume 50 μL is applied to the surface of a chicken fillet. The indicium is defined in the applied paste surface area using a computer-aided CO₂ laser (blue) working continuously, without an auxiliary gas and with a power of 10 W. In these conditions, legible and indelible marks of an excellent quality were obtained without affecting the organoleptic properties of the meat, these marks retaining integrity and resolution beyond the use-by date of the meat product.

A label comprising for example, a datamatrix code, or a QR type code can be defined using such a laser at a speed of 2000 mm/s. Other working combinations of paste and laser specification are detailed in the table below.

| | | Contrasting | | Laser | Laser |
|---|---|---|---|---|---|
| Carrier | Setting Agent | Agent | Additives | Color | power |
| Ethanol | Glucose- | TiO₂ (10%-50%) | Preservatives | Blue | 10 W |
| (20%-70%) | Fructose | | | (~9.4 μm) | |
| | syrup (10%-60%) | | | | |
| Acetone | Fructose (10%-50%) | | Antioxidants | Black | 30 W |
| (20%-70%) | | | | (~10.6 μm) | |
| Water | | | Emulsifiers | Red | 60 W |
| (10%-50%) | | | | (~10.3 μm) | |
| | | | Stabilizers | | |
| | | | Thickeners/gelling | | |
| | | | agents | | |

The additives listed above are optional and various combinations of additive can be employed according to the application, For example, where an inkjet printer is used, a stabilizer will likely be needed. If the paste is produced on an industrial scale, it is likely that a preservative will be required

As mentioned, one form of indicia which can be applied to food products comprise a datamatrix or QR code. Such a code can incorporate a large variety of data. For example individual products can be encoded with unique serial numbers or for example, “use by” information can be encoded in the code. Also, validity information including CRC codes or digital signatures can be included within the label indicia.

The above exemplary paste formulations provide indicia which are sufficiently durable to exceed the product use by date and so even if they are no longer legible after that date, this then indicates the product is past its use by date. It will also be appreciated that marked meat can be frozen and the label can remain legible.

The exemplary paste formulations are thin enough to be dispensed in one smooth motion and self level on contact with the meat product surface.

Sufficient evaporation of the carrier solvent causes the paste to resist flow beyond the desired label area.

It will also be appreciated that while the above exemplary paste formulations are edible, they can equally be washed off food products during preparation and prior to consumption. In many cases, the label would in any case disappear during cooking.

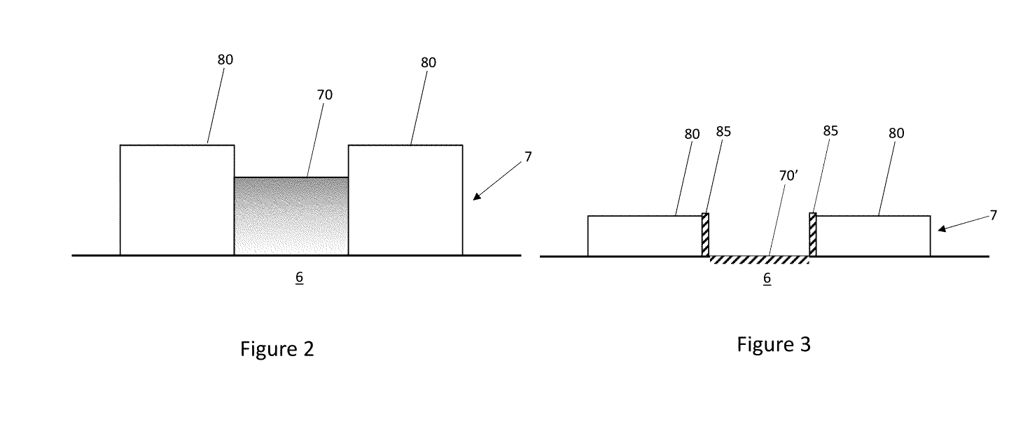

Referring to FIG. 2, in the above described embodiments, a label is defined using positive exposure where one or more portions 70 of a patch of paste 7 applied to a product 6 are exposed to laser light and fused so that they present a surface of contrasting color or opacity relative to unexposed portions 80 of the patch of paste 7. It will be noted that a fused portion 70 may also be slightly ablated relative to the unexposed portions 80. Such an approach can be employed with a relatively thick layer of paste ranging in thickness from 100-700 um.

In such examples, the initial patch of paste can be opaque and, if the unexposed portions 80 are retained, the technique relies on exposure to change the color of the exposed portion(s) 70 so that they contrast with the unexposed portions 80.

Referring now to FIG. 3, in alternative embodiments, a thinner layer of paste 7 ranging in thickness from 25-100 um can be applied to the product 6. In this case, the exposed portion of the patch of paste is substantially completely ablated and the surface 70′ of the meat product then exposed is marked so that it changes color as it is exposed. Also, the side walls 85 of the paste portion which fuse as the portion is ablated change color or opacity. In this case, the unexposed portions 80 of the patch of paste 7 can be left to set through evaporation of the carrier, so that the final label provides portions 70′ and 85 whose appearance contrasts with the remainder 80 of the patch of paste to define a legible label.

Having sufficiently described the nature of the present invention, as well as a way of putting it into practice, it must only be added that it is possible to introduce changes of shape, materials and arrangement in it as a whole or in the parts forming it, provided that said alterations do not substantially vary said invention.

Those skilled in the art will recognize improvements and modifications to the preferred embodiments of the present disclosure. All such improvements and modifications are considered within the scope of the concepts disclosed herein and the claims that follow.

What is claimed is:

1. A food paste comprising a carrier, a setting agent and a contrasting agent, a portion of said paste being selectively fusible to define a solid indicium optically contrasting with an underlying portion of food.

2. A food paste as claimed in claim 1 wherein said setting agent changes color or opacity when fused.

3. A food paste as claimed in claim 1 wherein said setting agent comprises a sugar which caramelizes when heated.

4. A food paste as claimed in claim 1 wherein said carrier comprises one of: from 20-70% ethanol; from 20-70% acetone; or from 10-50% water by weight.

5. A food paste as claimed in claim 1 wherein said setting agent comprises one of: from 10%-60% Glucose-Fructose syrup; or from 10%-50% Fructose by weight.

6. A food paste as claimed in claim 1 wherein said contrasting agent comprises from 10%-50% TiO2 by weight.

7. A food paste as claimed in claim 1 further comprising one or more of:
preservatives; antioxidants; emulsifiers; stabilizers; or thickeners/gelling agents.

8. A food paste as claimed in claim 1 wherein said paste comprises 44% ethanol, 19% TiO2 and 37% fructose by weight.

9. A system for applying indicia to food products, the system comprising a dispenser for successively dispensing a quantity of food paste onto a respective surface of a portion of food, said food paste comprising a carrier, a setting agent and a contrasting agent; and a fusing unit for fusing a dispensed portion of said paste to provide at least one solid indicium on said food product, said indicium optically contrasting with said portion of food.

10. A system as claimed in claim 9 wherein said fusing unit is arranged to produce at least one focused light beam.

11. A system as claimed in claim 10 wherein said light beam is a laser light beam.

12. A system as claimed in claim 10 wherein the focused light beam is arranged to cause a change in color or opacity of an exposed fused portion of said paste.

13. A system as claimed in claim 10 wherein the focused light beam is arranged to ablate an exposed portion of said paste while fusing a side wall of the ablated portion to cause a change in color or opacity of said fused side wall.

14. A system as claimed in claim 13 wherein the system is arranged to allow an unexposed portion of said paste to set passively.

15. A system as claimed in claim 13 wherein the focused light beam is arranged to cause a change in color of a portion of a surface of said food product exposed by said ablation.

16. A system as claimed in claim 9 wherein the food product comprises skinless meat.

17. A system as claimed in claim 9 wherein said quantity is 50 μL.

18. A system as claimed in claim 10 wherein said light beam has a wavelength of between about 9.4 μm and 10.6 μm.

19. A system as claimed in claim 10 wherein said light beam has an output power of between about 10W and 60W.

20. A system as claimed in claim 9 wherein said fusing unit comprises a CO2 laser with an output power of 10W.

21. A system as claimed in claim 11 wherein said laser is arranged to traverse said portion of food at a speed of 2000 mm/s.

22. A system as claimed in claim 9 wherein said fusing unit is arranged to define one of a datamatrix code, or a QR type code on said portion of food.
